(19) United States
(12) Patent Application Publication
(10) Pub. No.: US 2014/0047452 A1
(43) Pub. Date: Feb. 13, 2014

(54) Methods and Systems for Scalable Computing on Commodity Hardware for Irregular Applications

(71) Applicants: Battelle Memorial Institute, Richland, WA (US); University of Washington through its Center for Commercialization, Seattle, WA (US)

(72) Inventors: Luis CEZE, Seattle, WA (US); Jacob Eric NELSON, Seattle, WA (US); Brandon HOLT, Seattle, WA (US); Brandon MYERS, Seattle, WA (US); Simon KAHAN, Seattle, WA (US); Mark H. OSKIN, Seattle, WA (US)

(73) Assignees: Battelle Memorial Institute, Richland, WA (US); University of Washington through its Center for Commercialization, Seattle, WA (US)

(21) Appl. No.: 13/834,560

(22) Filed: Mar. 15, 2013

Related U.S. Application Data
(60) Provisional application No. 61/681,053, filed on Aug. 8, 2012.

(51) Int. Cl. G06F 9/50

(52) U.S. Cl. CPC G06F 9/5027
USPC 718/104

(57) ABSTRACT

A computing system for scalable computing on commodity hardware is provided. The computing system includes a first computing device communicatively connected to a second computing device. The first computing device includes a processor, a physical computer-readable medium, and program instructions stored on the physical computer-readable medium and executable by the processor to perform functions. The functions include determining a first task associated with the second computing device and a second task associated with the second computing device are to be executed, assigning execution of the first task and the second task to the processor of the first computing device, generating an aggregated message that includes (i) a first message including an indication corresponding to the execution of the first task and (ii) a second message including an indication corresponding to the execution of the second task, and sending the aggregated message to the second computing device.

### CROSS-REFERENCE TO RELATED APPLICATIONS

The present non-provisional utility application claims priority under 35 U.S.C. §119(e) to co-pending provisional application number U.S. 61/681,053 filed on Aug. 8, 2012, the entire contents of which are herein incorporated by reference.

### STATEMENT OF U.S. GOVERNMENT INTEREST

This invention was made with government support under DE-ACO5-76RL01830, awarded by DOE. The government has certain rights in the invention.

### BACKGROUND

Commodity cluster computing (sometimes referred to as a multinode high speed network system or commodity cluster) includes using large numbers of computing components for parallel computing in attempt to obtain the greatest amount of useful computation at low cost. In other words, clusters of commodity computers and switches may be used to speed up the execution of programs beyond the speed/performance achievable on a single-board computer. However, the use of commodity clusters may have certain drawbacks. For instance, commodity clusters may have high inter-node communication cost and may lack globally shared memory.

Generally, commodity cluster computing is used for regular large-scale scientific programs and/or network services such as web search and mail. Such applications or programs generally consist of units of work (tasks) that are mainly independent allowing parallel execution with little inter-process communication or with predictable, regular communication among contexts. In other words, such programs have a high degree of regularity and therefore may not necessarily be impacted, for example, by the high inter-node communication costs generally associated with commodity cluster computing.

In contrast, irregular applications (e.g., graph analytics) are characterized by irregular data access patterns (e.g., unbalanced trees and graphs), irregular control structures (namely conditional statements), and irregular communication patterns, all of which may create complex application behavior. For example, irregular applications may generate tasks with work, interdependences, or memory accesses that are highly sensitive to input. Classic examples of irregular applications may include branch and bound optimization, SPICE circuit simulation, contact algorithms in car crash analysis, and network flow, among other examples. Some contemporary examples include processing large graphs in the business, national security, machine learning, data-driven science, and social network computing domains, among other examples. Given the relatively large amount of data involved in these emerging applications, fast response may require multinode systems. Accordingly, a means to enable scalable performance of irregular applications on such systems can be appreciated.

### SUMMARY

This disclosure generally involves methods and systems for scalable computing on commodity hardware for irregular applications.

In a first embodiment, a computing system is provided. The computing system includes a first computing device that is communicatively connected to a second computing device. The first computing device includes at least one processor, a physical computer-readable medium, and program instructions stored on the physical computer-readable medium and executable by the at least one processor to perform functions. The functions include determining that a first task associated with the second computing device and a second task associated with the second computing device are to be executed. The functions also include assigning execution of the first task and the second task to the at least one processor of the first computing device. The functions additionally include generating an aggregated message that includes (i) a first message that includes an indication corresponding to the execution of the first task and (ii) a second message that includes an indication corresponding to the execution of the second task. The functions further include sending the aggregated message to the second computing device.

In a second embodiment, a method is provided. The method includes determining, using at least one processor of a first computing device, that a first task associated with a second computing device and a second task associated with the second computing device are to be executed. The first computing device is communicatively connected to the second computing device. The method also includes assigning the execution of the first task and the second task to the at least one processor of the first computing device. The method additionally includes generating an aggregated message that includes (i) a first message that includes an indication corresponding to the execution of the first task and (ii) a second message that includes an indication corresponding to the execution of the second task. The method further includes sending the aggregated message to the second computing device.

In a third embodiment, a physical computer-readable medium having stored thereon program instructions executable by a first computing device to cause the first computing device to perform functions is provided. The functions include determining, using at least one processor of the first computing device, that a first task associated with a second computing device and a second task associated with the second computing device are to be executed. The first computing device is communicatively connected to the second computing device. The functions also include assigning the execution of the first task and the second task to the at least one processor of the first computing device. The functions additionally include generating an aggregated message that includes (i) a first message that includes an indication corresponding to the execution of the first task and (ii) a second message that includes an indication corresponding to the execution of the second task. The functions further include sending the aggregated message to the second computing device.

The foregoing summary is illustrative only and should not be taken in any way to be limiting. In addition to the illustrative aspects, embodiments, and features described above, further aspects, embodiments, and features will become apparent by reference to the figures and the following detailed description.

### BRIEF DESCRIPTION OF THE DRAWINGS

FIG. 1 is a schematic illustration of a commodity cluster of multicore computers, according to an example embodiment.

FIG. 2 is a simplified illustration of an example multicore computer that may be used in the commodity cluster of multicore computers of FIG. 1, according to an example embodiment.

FIG. 3A is a schematic illustrating a subset of the commodity cluster of multicore computers of FIG. 1, according to an example embodiment.

FIG. 3B is a schematic illustrating a distributed shared memory, according to an example embodiment.

FIG. 4A is a flow diagram illustrating techniques for enabling multicore computers to provide scalable performance, according to an example embodiment.

FIG. 4B is another flow diagram illustrating techniques for enabling multicore computers to provide scalable performance, according to an example embodiment.

FIG. 5 illustrates an example computer program product, according to an example embodiment.

### DETAILED DESCRIPTION

Example methods and systems are described herein. Any example embodiment or feature described herein is not necessarily to be construed as preferred or advantageous over other embodiments or features. The example embodiments described herein are not meant to be limiting. It will be readily understood that certain aspects of the disclosed systems and methods can be arranged and combined in a wide variety of different configurations, all of which are contemplated herein.

Furthermore, the particular arrangements shown in the Figures should not be viewed as limiting. It should be understood that other embodiments may include more or less of each element shown in a given Figure. Further, some of the illustrated elements may be combined or omitted. Yet further, an example embodiment may include elements that are not illustrated in the Figures. In the Figures, like numerals denote like entities.

### A. Overview

In addition to some of the difficulties associated with irregular applications noted above, irregular applications may also exhibit little spatial locality. For example, data references of a given task of the irregular application may be spread randomly across the entire memory of a multinode system. Accordingly, memory hierarchy features that exist in current commodity clusters may be undesirably ineffective. For example, caches may be of little assistance with such low data re-use and spatial locality, and commodity prefetching hardware may only be effective when addresses are known many cycles before the data is consumed or the accesses follow a predictable pattern, neither of which occurs in irregular applications. Consequently, commodity microprocessors may stall often when executing irregular applications.

Moreover, irregular applications may frequently request small amounts of off-node data (data that does not reside on a node currently performing a task). On multinode systems, the difficulties presented by low locality are analogous, and may be exacerbated by the increased latency of going off-node. Irregular applications may also present a challenge to currently available and mass marketed network technology, which may be designed to transfer large blocks of data, not the smaller references and/or data blocks emitted by irregular application tasks.

While some irregular applications can be restructured to better exploit locality, aggregate requests to increase message size, and manage the additional challenges of load balance and synchronization across multinode systems, the work may be formidable and may require expert knowledge and skills pertaining to distributed systems. Many important irregular applications naturally offer large amounts of concurrency (allowing computational processes to be executed in parallel), which may be useful to help tolerate the latency of data movement.

For example, the generally known Tera MTA-2 system supports irregular applications by using concurrency to help tolerate latencies. To do so, the fully custom Tera MTA-2 system includes a large distributed shared memory with no caches. Using clock cycle timing, each processor of the Tera MTA-2 system may execute an instruction chosen from one of its 128 hardware thread contexts, a number that may fully hide memory access latency. However, while the Tera MTA-2 system may eradicate some of the difficulties associated with irregular applications, the Tera MTA-2 system may not be cost-effective for applications that may exploit locality, and the Tera MTA-2 system may experience relatively poor single-thread performance.

Within examples, a software latency tolerant runtime system that may allow, for example, a commodity x86 distributed-memory high performing computing (HPC) cluster to be programmed as if it were a single large shared-memory machine and may provide scalable performance for irregular applications is disclosed. The system may, for example, help resolve some of the performance discontinuities prevalent in commodity hardware thereby giving good performance when there is little locality to be exploited.

However, the software latency tolerant runtime system disclosed herein is not limited to a commodity x86 distributed high performing computing cluster and may be implemented using other high performance computing systems.

The disclosed system may also leverage as much freely available and commodity infrastructure as possible. The system may use, for example, unmodified Linux for the operating system and an off-the-shelf user-mode InfiniBand® device driver stack. Message Processing Interface (MPI) MPI may be used for process setup and tear down. GAS-net may be used as the underlying mechanism for remote memory reads and writes using active message invocations. To this commodity hardware and software mix, the system may add three main software components: (1) a lightweight tasking layer that may support a context switch (switching between tasks) in a few nanoseconds and distributed global load balancing; (2) a distributed shared memory layer that may support normal access operations such as read and write as well as synchronizing operations such as fetch-and-add; and (3) a message aggregation layer that may combine short messages to mitigate inefficiencies that may be associated with commodity networks as a result of small packet sizes produced by irregular applications.

Accordingly, the latency tolerant runtime system may, for purposes of explanation, trade latency for throughput. For example, the system may increase latency in key components of the runtime system, and as a result it may be possible to increase effective random access memory bandwidth (e.g., by delaying and aggregating messages), synchronization bandwidth (e.g., by delegating operations to remote nodes), and the ability to improve load imbalance (e.g., by work stealing).

### B. Example Systems

Example systems will now be described. The methods and functions described herein may, for example, be carried out using the described system. However the system is set forth for purposes of example and explanation and is not intended to be limiting. It will be readily understood by those having skill in the art that other systems may be used to carry out the methods and functions described herein.

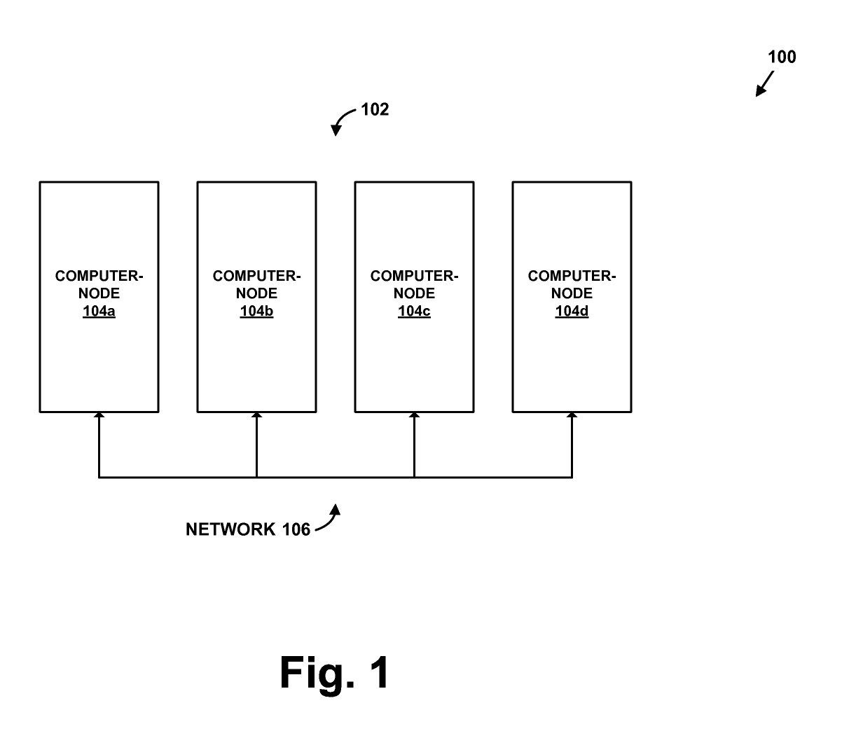

FIG. 1A illustrates a block diagram of one example network environment 100 in which the methods and systems disclosed herein may be implemented. The illustrated environment 100 includes a commodity cluster of multicore computer-nodes 102 that may include computer-nodes 104a, 104b, 104c, and 104d . . . , 104(N). Each of the computer-nodes 104a-d may be configured to communicate with each other over Network 106. Each computer-node 104a-d may include one or more processors, and each processor can contain one or more processor cores that may be, for example, capable of single-threaded execution. In addition each computer-node 104a-d may include memory and optional storage (not shown).

In some implementations Network 106 may include a high speed network such as a Fibre Channel network, an InfiniBand® network, or a RapidIO network. In other implementations, Network 106 may also include one or more of a LAN, a WAN, a wireless network, an intranet, or the Internet.

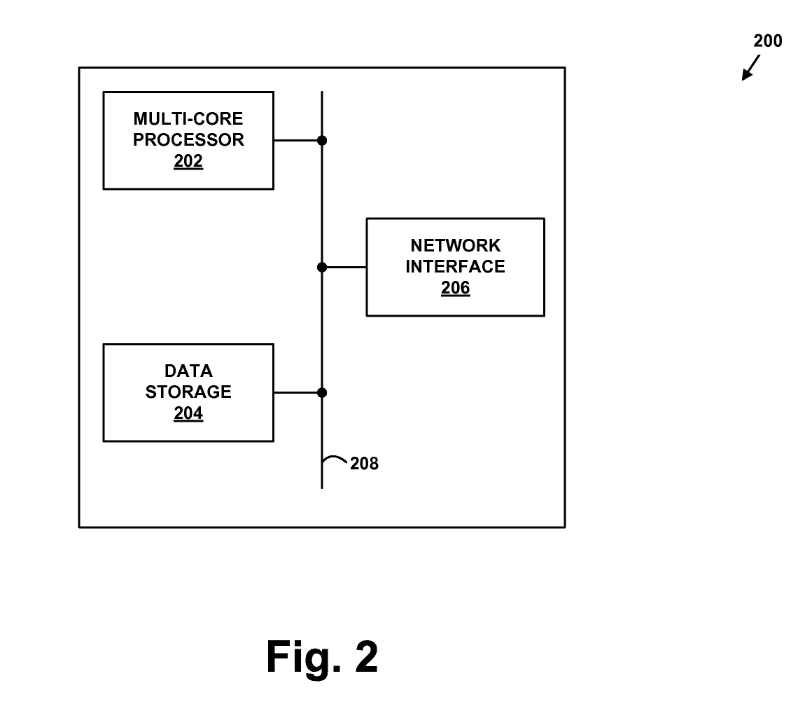

FIG. 2 is a simplified block diagram depicting an example computer-node 200 that may be configured to operate in accordance with various implementations. For example, computer-node 200 may be used as any one of computer-nodes 104a-d in network environment 100. Computer-node 200 may be a personal computer, an embedded computer, a laptop computer, or some other type of device that communicates with other communication devices via point-to-point links or via a network, such as Network 106 shown in FIG. 1, for example. In a basic configuration, computer-node 200 may include processor 202, data storage 204, and network interface 206. A memory bus 208 may be used for communicating among the processor 202, data storage 204, and network interface 206.

Processor 202 may include one or more CPUs (cores), such as one or more general purpose processors and/or one or more dedicated processors (e.g., application specific integrated circuits (ASICs) or digital signal processors (DSPs), etc.). Data storage 204, in turn, may comprise volatile and/or non-volatile memory and can be integrated in whole or in part with processor 202. Data storage 204 may hold program instructions executable by processor 202, and data that is manipulated by these instructions, to carry out various logic functions described herein. For example, data storage 204 may include program instructions configured by a user (e.g., programmer) that allows the system to exploit parallelism. Other instructions may be included as well. Alternatively, the logic functions can be defined by hardware, firmware, and/or any combination of hardware, firmware, and software.

Network interface 206 may take the form of a wireless connection, perhaps operating according to IEEE 802.11 or any other protocol or protocols used to communicate with other communication devices or a network. In other examples network interface 206 include a wired-communication interface or communication link, each capable of operating according to the same or different protocols. The communication link may include an actual physical link or it may be a logical link that uses one or more actual physical links. In such cases, Network interface may include interfaces that allow, for example, computer-node 200 to connect to other network devices using a serial link, for example.

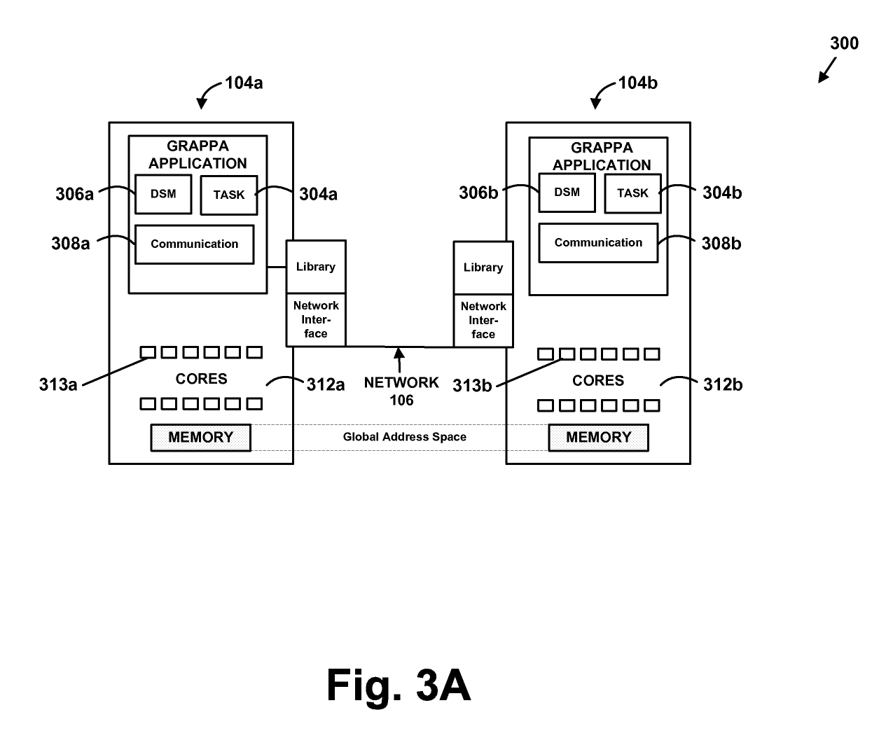

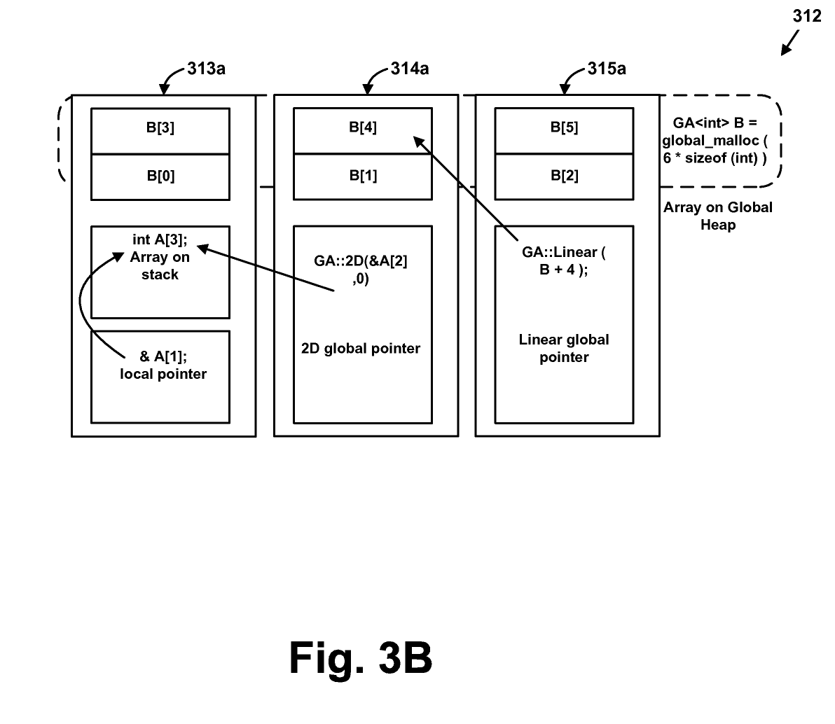

FIG. 3A is a schematic illustrating a subset 300 of the commodity cluster of multicore computer-nodes of FIG. 1 implementing the latency tolerant runtime system. As noted above, the example system may include three main software components or layers. Each of them will be discussed, at a high level, in turn below. While an overview of these example software components is provided to help describe an example runtime latency tolerant system in which the example methods may be carried out, such an overview is provided for purposes of example and explanation only, and should not be taken to be limiting.

Tasking Component 304a, 304b

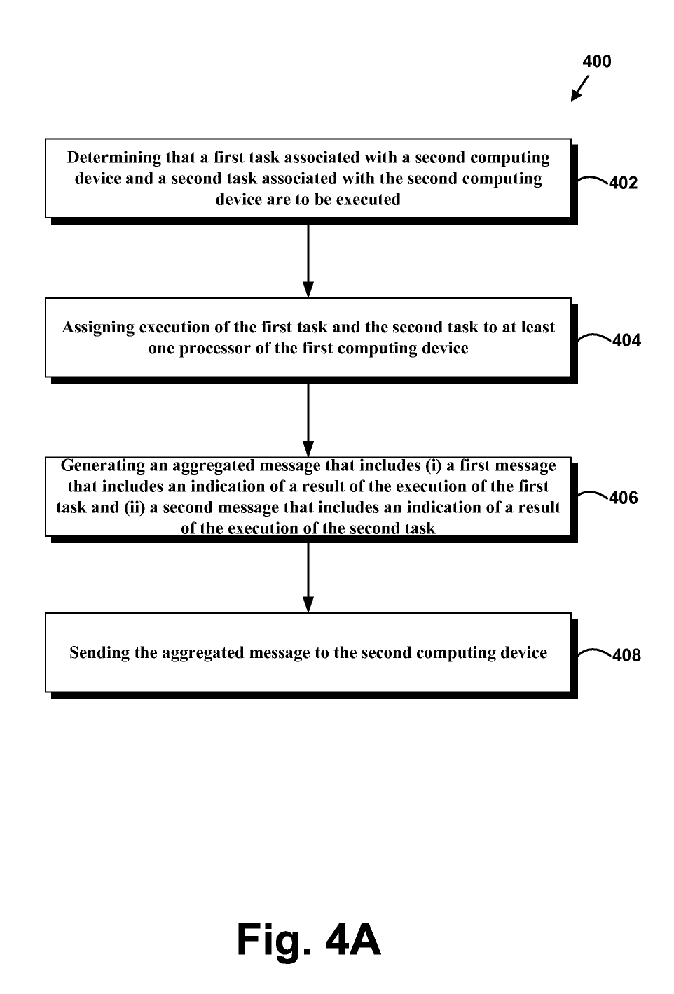

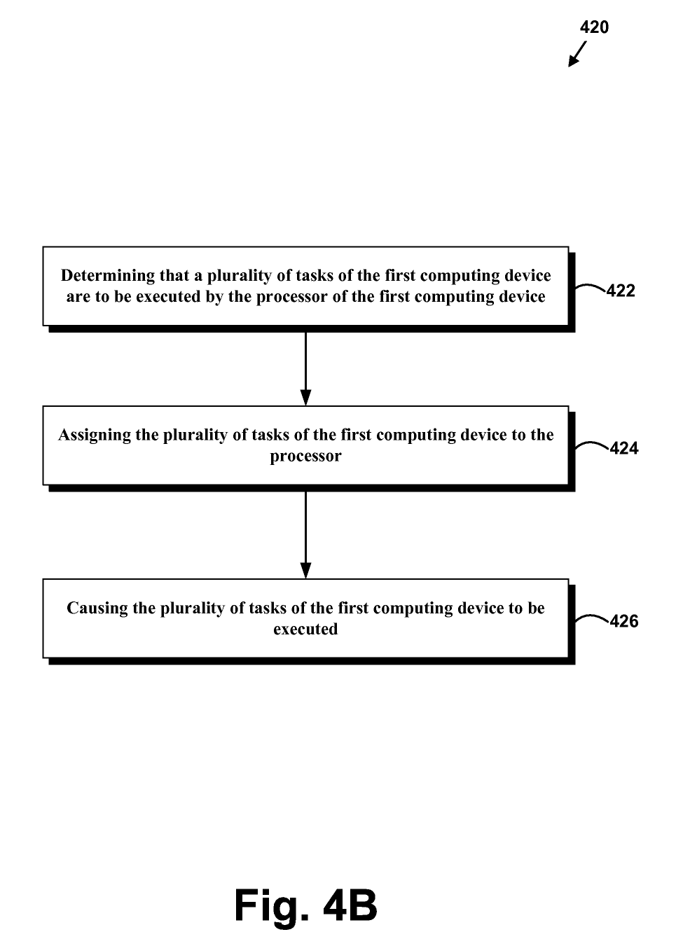

The example system may support multithreading to tolerate communication latency and global distributed work stealing (i.e., tasks can be stolen from any computer-node in the system and executed), which may provide automated load balancing. Tasks will be discussed in more detail in reference to FIG. 4A.

Distributed Shared Memory 306a, 306b

The distributed shared memory (DSM) may provide support for access to data anywhere in the system. It may support synchronization of operations on global data, may provide explicit local caching of any memory in the system, and may provide operation on remote data (e.g., delegating operations to a home node). Integrating the tasking system and the DSM system may offer high aggregate random access bandwidth for accessing remote data.

Applications written for the example system may utilize two forms of memory: local and global. Local memory is local to a single core in the system. Accesses to local memory may occur through conventional pointers. The compiler may emit an access and the memory may be manipulated directly. Applications may use local accesses for a number of things in the system. For example, local accesses may be used with for stack associated with a task, accesses to localized global memory in caches (see below), and accesses to debugging infrastructure that is local to each system node. Local pointers may not access memory on other cores, and may only be valid only on their home core.

Large data that is expected to be shared and accessed with low locality may be stored in a global memory of the system. The stored global data may be accessed through various calls into an API of the system.

Two methods may be provided for storing data in the global memory. The first may include a distributed heap striped across all the machines in the system (e.g., computer-nodes 104a-d) in a block cyclic fashion (many other policies are possible, for example, on an object basis or application-configurable way). Example calls may include globalmalloc and globalfree used to allocate and deallocate memory in the global heap. Addresses to memory in the global heap may use linear addresses. Choosing the block size may involve trading off sequential bandwidth against aggregate random access bandwidth. Smaller block sizes may help spread data across all the memory controllers in the cluster, but larger block sizes allow the locality-optimized memory controllers to provide increased sequential bandwidth. The block size, which is configurable, may be set to 64 bytes, or the size of a single hardware cache line, in order to, for example, exploit spatial locality when available. The heap metadata may be stored on a single node. Currently all heap operations may serialize through this node.

Any local data on a stack or heap of a particular core may be exported to the global address space to be made accessible to other cores across the system. Addresses to global memory allocated in this way may use 2D global addresses. Using a traditional PGAS addressing model, each address may be a tuple of a rank in the job (or global process ID) and an address in that process. The lower 48 bits of the address may hold a virtual address in the process. The top bit may be set to indicate that the reference is a 2D address (as opposed to linear address). This leaves 15 bits that may be used for network endpoint ID.

Any node-local data can be made accessible by other nodes in the system by wrapping the address and node ID into a 2D global address. This address can then be accessed with a delegate core and can also be cached by other nodes. At the destination the address may be converted into a canonical x86 address by replacing the upper bits with the sign-extended upper bit of the virtual address. 2D addresses may refer to memory allocated from a heap of a single process or from a stack of a task. FIG. 3B shows how 2D and linear addresses can refer to memory of other cores. In FIG. 3B cores 313a, 314a, and 315a of cores 312a of computer-node 104a are shown.

Two general approaches may be used to access global memory. When, for example, a programmer expects a computation on shared data to have spatial locality to exploit, cache operations may be used. When there is no locality to exploit, delegate operations may be used.

The latency tolerant runtime system may include an API to fetch a global pointer of any length and may return a local pointer to a cached copy of the global memory. The system cache operations may have read-only and read-write variants, along with a write-only variant used to initialize data structures. Caching in the system may additionally include a mechanism for exploiting temporal locality by operating on the data locally. The system may perform the mechanics of gathering data from multiple system nodes and may present a conventional appearing linear block of memory as a local pointer into a cache.

When the access pattern has low-locality, it may be more efficient to modify the data on its home core rather than bringing a copy to the requesting core and returning it after modification. Delegate operations may provide this capability. Applications can dispatch computation to be performed on individual machine—word sized chunks of global memory to the memory system itself (e.g., fetch-and-add).

Delegate operations may always be executed at the home core of their address, and while arbitrary memory operations can be delegated, the system may restrict the use of delegate operations in three ways to make them more useful for synchronization. First, the system may limit each task to one outstanding delegate operation thereby possibly avoiding the possibility of reordering in the network. Second, the system may limit delegate operations to operate on objects in the 2D address space or objects that fit in a single block of the linear address space to possibly satisfy them with a single network request. Finally, no context switches may be allowed while the data is being modified. Given these restrictions, the system can ensure that delegate operations for the same address from multiple requesters are always serialized through a single core in the system, providing atomic semantics without using atomic operations.

Communication Layer 308a, 308b

Since irregular applications tend to require frequent communication of small requests, the communication layer may aggregate small messages into large ones to better exploit the network the system is operating in. The communication layer will be discussed in more detail in reference to FIG. 4A.

### C. Example Methods

FIG. 4A illustrates a method 400 that may be carried out using the commodity cluster of multicore computer-nodes 102 in network environment 100, described above with regard to FIGS. 1-3, for example. Method 400 may provide for scalable performance of irregular applications, according to an example embodiment. Method 400 may include one or more operations, functions, or actions as illustrated by one or more of blocks 402-408. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

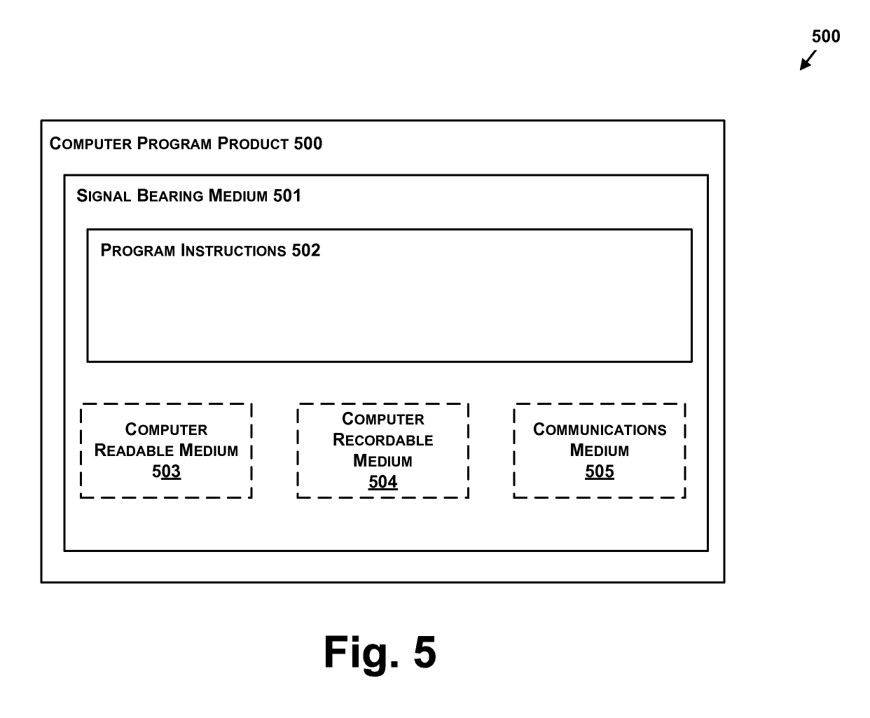

In addition, for the method 400 and other processes and methods disclosed herein, the flowchart shows functionality and operation of one possible implementation of present implementations. In this regard, each block may represent a module, a segment, or a portion of program code, which includes one or more instructions executable by a processor or computing device for implementing specific logical functions or steps in the process. The program code may be stored on any type of computer readable medium or memory, for example, such as a storage device including a disk or hard drive. The computer readable medium may include non-transitory computer readable medium, for example, such as computer-readable media that stores data for short periods of time like register memory, processor cache and Random Access Memory (RAM). The computer readable medium may also include non-transitory media, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, for example, or a tangible storage device, such as the one described in reference to FIG. 5.

First, at block 402, method 400 includes determining that a first task associated with a second computing device and a second task associated with the second computing device are to be executed. The determination may be made by a first computing device. The first and second computing devices may be the same or similar to any of computer-nodes 104a-d discussed in reference to FIG. 1 or to computer-node 200 discussed in reference to FIG. 2. For example, the first computing device may be computer-node 104a and the second computing device may be computer-node 104b. The first computing device and second computing device may be communicatively connected with each other in a high speed network similar to or the same as network 106 depicted in FIG. 1. In one example, the first computing device and second computing device may be communicatively connected to each other in an InfiniBand® network. Other high speed networks may be used as well.

For purposes of explanation, one may consider a basic unit of execution to be the task. A task may include a unit of work that may need to be performed by one or more of the computer-nodes, such as computer-node 104a, in order to execute an application or program that may be running on a commodity cluster using the system. Each task may be represented, for example, by a function pointer and arguments of the function pointer. A large number of tasks may be multiplexed into a single computer core with lightweight context switching.

More specifically, example tasks may be, for instance, 32-byte entities: a 64-bit function pointer plus three 64-bit arguments. The function pointer may provide an address for the routine to run. The three arguments may include, for example, a private argument, which may include a loop index; a shared argument, which may include data shared amongst a group of tasks, or the number of loop iterations to be performed by the particular task; and a synchronization argument, which may be used to determine when all tasks that are part of a loop have finished and may include a global pointer to a synchronization object allocated at the core that initiated a group of tasks. While these arguments may include the most common uses of the three task arguments, they may be treated as arbitrary 64-bit values during runtime, and can, in other examples, be used for any purpose.

To determine that the first task and second task are to be executed, the system may seek to increase, or otherwise establish, parallelism. For example, when a programmer identifies work that can be done in parallel, the programmer may cause the work to be wrapped up in a function and queued with its arguments for later execution. In another example, a programmer can cause a task to be performed on a specific core in the system or at the home core of a particular memory location. In a further example, the programmer can invoke a parallel for loop, provided that the trip count is known at loop entry. In further examples, a programmer may want to run a small piece of code on a particular core in the system without waiting for execution resources to be available.

Accordingly, in some examples, before determining that the first task associated with the second computing device and the second task associated with the second computing device are to be executed the first computing device may determine that the first computing device has no tasks to be assigned for execution and determine that the second computing device has a task queue comprising the first task and the second task that are to be executed.

Once the first task and the second task have been determined, at block 404, method 400 includes assigning the execution of the first task and the second task to the at least one processor of the first computing device. As noted above, the first computing device may be computer-node 104a. Accordingly, the first task and the second task may be assigned, for example, to a core 313a of a plurality of cores 312a of computer-node 104a (shown in FIG. 3A). The assignment may be performed based on a scheduler associated with each computer-node, or in the current example, a scheduler associated with computer-node 104a. Upon determining a new task is to be executed, a new task may be allocated to a stack of executable tasks, bound to the particular executing core, and executed. During execution, a task may yield control of its core whenever it performs a long-latency operation (such as communication or accessing remote data), allowing the processor to remain busy while waiting for the operation to complete. Tasks may not be allocated any execution resources until the scheduler decides to run them.

Along with assigning execution of a task, each scheduler of each computer-node may have three main operations to perform including: servicing communication requests; rescheduling tasks that may have been waiting on long-latency operations; and possibly assigning ready tasks to worker resources that have become idle. Workers may include a collection of status bits and a stack that is allocated at each core.

Each scheduler may also have three queues associated with it: a ready worker queue that includes a FIFO queue of tasks that may be matched with workers and may be ready to execute; a private task queue that includes a FIFO queue of tasks that may be configured to run on a core of the computer-node associated with the scheduler; and a public task queue that includes a LIFO queue of tasks that may be waiting to be matched with workers. Whenever a task yields or suspends, the scheduler may make a decision about what to do next.

For example, servicing communication requests may be given priority to ensure responsiveness, but to minimize overhead should context switches be frequent, servicing is performed only if sufficient time has elapsed. The scheduler may also determine if any workers with running tasks are ready to execute; if so, a worker may be scheduled. Finally, the scheduler may determine that if there are no workers ready to run, but there are tasks waiting to be matched with workers, an idle worker may be woken (or a new worker may be generated), matched with a task, and scheduled.

For example, referring back to FIG. 3A, a scheduler (not shown) associated with computer-node 104a (scheduler A) may perform any of the above noted operations to ensure tasks are executed on one or more of cores 312a and a scheduler (not shown) associated with computer-node 104b (scheduler B) may perform any of the above noted operations to ensure tasks are executed on one or more of cores 312b in a manner that allows a program to be appropriately executed.

When a particular scheduler finds no work to assign to its workers, it may commence to obtain work from other cores. It may choose a victim-core at random until it finds, for example, one with a non-zero amount of work in its public task queue. The scheduler may, for example, obtain half of the tasks it finds at the, thereby preventing any cores from being underutilized.

For example, if scheduler A associated with computer-node 104a determines that core 313a of computer-node 104a has no tasks to be performed, it may commence to obtain work associated with one of cores 312b such as core 313b of node 104b. If, for example, core 313b of computer-node 104b had four tasks scheduled, scheduler A may steal two of the four tasks to reassign to scheduler B. Other examples are possible as well. In other examples, any core in the commodity cluster of multicore computer-nodes 102 may obtain work from any other core in the commodity cluster of multicore computer-nodes 102.

Next, at block 406, method 400 includes generating an aggregated message that comprises (i) a first message that includes an indication corresponding to the execution of the first task and (ii) a second message that includes an indication corresponding to the execution of the second task. The indication corresponding to the execution of the first task may include at least one of a result of the execution of the first task or a request generated by the execution of the first task, and the indication corresponding to the execution of the second task may include at least one of a result of the execution of the second task or a request generated by the execution of the second task. Other information may be included in the indication corresponding to the execution of the first and second task as well.

In other words, the aggregated message may include data that may correspond to the execution of the first task and data that may correspond to the execution of the second task. The data may include data produced as a result of the execution of the particular task, or data requesting more computations or other data that may be required by the particular task to continue to execute.

To generate the aggregated message, an upper layer of the communication layer may be used to implement asynchronous active messages, and each message may consist of a function pointer, an optional argument payload, and an optional data payload. When a task sends a message, the message may be copied (or linked) to an aggregated-message queue associated with a destination of the message and the task may continue to be executed. As each task is executed, thereby producing a corresponding message, a lower networking layer may be used to aggregate the messages of the upper layer before sending the message to the destination.

In some examples, the first computing device may cause the first message and the second message to be sent to an aggregated-message queue associated with the second computing device.

Method 400 ends at block 408, which includes sending the aggregated message to the second computing device. The first computing device may cause the aggregated message to be sent to the second computing device. Referring back to the example above, the computer-node 104a may cause an aggregated message generated as a result of the execution of the two tasks stolen from computer-node 104b, core 313b to be sent to computer-node 104b.

The message may be sent upon the satisfaction of various conditions. For example, each computer-node may be associated with an aggregated-message queue. Each aggregated-message queue may have a message size threshold, such as 4096 bytes, for example. If the size in bytes of a particular aggregated-message queue is above the threshold, the contents of the queue may be sent immediately. In another example, each aggregated-message queue may have a wait-time threshold. If the oldest message in a particular aggregated-message queue has been waiting longer than this threshold, the contents of the aggregated-message queue may be sent immediately, even if the queue size is lower than the message size threshold. In yet another example, aggregated-message queues may be explicitly flushed in situations, for example, where a given programmer may desire to minimize the latency of a message at the cost of bandwidth utilization.

Accordingly, in some examples the aggregated-message queue may be associated with a message-size threshold, The first computing device may, before sending the aggregated message, determine that a size of the aggregated message is greater than the message-size threshold. Alternatively, the aggregated-message queue may be associated with a wait-time threshold. The first computing device may, before sending the aggregated message, determining that the aggregated message has been in the aggregated-message queue for a time period greater than the wait-time threshold.

The network layer may utilize polling to ensure the messages are properly being sent. For example, periodically when a context switch occurs, the scheduler switches to the network polling thread, which may have three responsibilities. First, it may poll the lower-level network layer to ensure it makes progress. Second, it may de-aggregate received messages and execute active message handlers. Third, it may check to see if any aggregation aggregated-message queues have messages that have been waiting longer than the threshold; if so, it may send them.

To actually send the messages, underneath the aggregation layer, the system may use the GAS-net communication library (shown in FIG. 3A) to actually move data. All interprocess communication, whether on or off a cluster node, may be handled by the GAS-net library. GAS-net may be able to take advantage of many communication mechanisms, including Ethernet® and InfiniBand® between nodes, as well as shared memory within a node. Other communication library services may be used or the runtime can interact with the network card directly.

FIG. 4A illustrates another method 420 that may be carried out using the commodity cluster of multicore computer-nodes 102 in network environment 100 and may be carried out in addition to method 400. In particular, method 420 may provide for the assignment of tasks by the first computing device to itself. In other words, in addition to determining tasks that need to be executed on a core of another computer-node, the first computing device (e.g., computer-node 104a) may determine its own tasks to be performed.

In FIG. 4B, method 420 additionally includes steps 422-426. Initially, at block 422, method 420 includes determining that a plurality of tasks of the first computing device are to be executed by the processor of the first computing device. For example, along with the first task and the second task that were determined to be executed at block 402, computer-node 104a may determine a plurality of tasks that are to be executed, in addition to the first task and the second task, by one of the cores 312a of the computer-node 104a. The tasks may be determined in the same or similar manner as the first task and second task discussed above with regard to block 402.

Once the plurality of tasks of the first computing device has been determined, method 420 includes, at block 424, assigning the plurality of tasks of the first computing device to a processor of the first computing device. The processor may be any of cores 312a of computer-node 104a, for example. The plurality of tasks may be assigned in the same manner as that described in reference to block 404. For example, computer-node 104a may assign the execution of the plurality of tasks to a one of the cores 312 other than core 313a. In other examples, the plurality of tasks may also be assigned to any of cores 312a.

At block 426, method 400, includes causing the plurality of tasks of the first computing device to be executed. The plurality of tasks may be executed in the same manner as described above in reference to block 408.

In some examples, the first computing device may store a state of the processor at a first time after a first task of the plurality of tasks has been caused to be executed, may cause a second task of the plurality of tasks to be executed, and may cause, after causing the second task to be executed, the processor to restore the state at a second time (different than the first time) so as to allow the first task to continue to execute. In other words, in some examples, the plurality of tasks may be executed together or in a non-sequential fashion allowing multiple tasks to be performed at once.

In other examples a third computing device may execute one of the first task, the second task or the plurality of tasks determined by method 400. The third computing device may include a particular core assigned to perform a task by the first computing device, computer-node 104a. Upon execution of the assigned task (of the first task, the second task or the plurality of tasks) the first computing device may receive from the third computing device a third message that indicates a result of the execution of the assigned task. The indication may be the same as the indications described at block 406. Upon receiving the third message, in some examples, the third message may be added to the aggregated message generated at block 406.

Accordingly, aggregated messages may include message generated by tasks performed off-node as well as tasks performed on-node.

In some implementations, the disclosed methods may be implemented as computer program instructions encoded on physical computer-readable storage media in a machine-readable format, or on other non-transitory media or articles of manufacture. FIG. 5 is a schematic illustrating a conceptual partial view of an example computer program product that includes a computer program for executing a computer process on a computing device, arranged according to at least some implementations presented herein.

In one embodiment, the example computer program product 500 is provided using a signal bearing medium 501. The signal bearing medium 501 may include one or more programming instructions 502 that, when executed by one or more processors may provide functionality or portions of the functionality described above with respect to FIGS. 1-3. In some examples, the signal bearing medium 501 may encompass a computer-readable medium 503, such as, but not limited to, a hard disk drive, a Compact Disc (CD), a Digital Video Disk (DVD), a digital tape, memory, etc. In some implementations, the signal bearing medium 501 may encompass a computer recordable medium 505, such as, but not limited to, memory, read/write (R/W) CDs, R/W DVDs, etc. In some implementations, the signal bearing medium 501 may encompass a communications medium 505, such as, but not limited to, a digital and/or an analog communication medium (e.g., a fiber optic cable, a waveguide, a wired communications link, a wireless communication link, etc.). Thus, for example, the signal bearing medium 501 may be conveyed by a wireless form of the communications medium 505 (e.g., a wireless communications medium conforming with the IEEE 802.11 standard or other transmission protocol).

The one or more programming instructions 502 may be, for example, computer executable and/or logic implemented instructions. In some examples, a computing device such as computer-node 200 of FIG. 2 may be configured to provide various operations, functions, or actions in response to the programming instructions 502 conveyed to the computer-node 200 by one or more of the computer readable medium 503, the computer recordable medium 504, and/or the communications medium 505.

While various aspects and implementations have been disclosed herein, other aspects and implementations will be apparent to those skilled in the art. The various aspects and implementations disclosed herein are for purposes of illustration and are not intended to be limiting, with the true scope being indicated by the following claims, along with the full scope of equivalents to which such claims are entitled. It is also to be understood that the terminology used herein is for the purpose of describing particular implementations only, and is not intended to be limiting.

What is claimed is:

1. A computing system comprising a first computing device that is communicatively connected to a second computing device, wherein the first computing device comprises:
at least one processor;
a physical computer-readable medium; and
program instructions stored on the physical computer-readable medium and executable by the at least one processor to perform functions comprising:
determining that a first task associated with the second computing device and a second task associated with the second computing device are to be executed;
assigning execution of the first task and the second task to the at least one processor of the first computing device;
generating an aggregated message that comprises (i) a first message that comprises an indication corresponding to the execution of the first task and (ii) a second message that comprises an indication corresponding to the execution of the second task; and
sending the aggregated message to the second computing device.

2. The computing system of claim 1,
wherein the indication corresponding to the execution of the first task comprises at least one of a result of the execution of the first task or a request generated by the execution of the first task, and
wherein the indication corresponding to the execution of the second task comprises at least one of a result of the execution of the second task or a request generated by the execution of the second task.

3. The computing system of claim 1, further comprising program instructions executable by the at least one processor to perform functions comprising:
before determining that the first task associated with the second computing device and the second task associated with the second computing device are to be executed:
determining that the first computing device has no tasks to be assigned for execution; and
determining that the second computing device has a task queue comprising the first task and the second task.

4. The computing system of claim 1, further comprising program instructions executable by the at least one processor to perform functions comprising:
causing the first message and the second message to be sent to an aggregated-message queue, wherein the aggregated-message queue is associated with the second computing device.

5. The computing system of claim 4,
wherein the aggregated-message queue is associated with a message-size threshold,
the computing system further comprising program instructions executable by the at least one processor to perform functions comprising:
before sending the aggregated message, determining that a size of the aggregated message is greater than the message-size threshold.

6. The computing system of claim 4,
wherein the aggregated-message queue is associated with a wait-time threshold,
the computing system further comprising program instructions executable by the at least one processor to perform functions comprising:
before sending the aggregated message, determining that the aggregated message has been in the aggregated-message queue for a time period greater than the wait-time threshold.

7. The computing system of claim 1, further comprising program instructions executable by the at least one processor to perform functions comprising:
before determining that the first task of the second computing device and the second task of the second computing device are to be executed:
determining that a plurality of tasks of the first computing device are to be executed by the at least one processor of the first computing device;
assigning the plurality of tasks of the first computing device to the at least one processor; and
causing the plurality of tasks of the first computing device to be executed.

8. The computing system of claim 7, further comprising program instructions executable by the at least one processor to perform functions comprising:
causing a third computing device to execute at least one of the first task, the second task, and the plurality of tasks; and
receiving from the third computing device a third message that indicates a result of at least one of the execution of the first task, the execution of the second task, or the execution of the plurality of tasks.

9. The computing system of claim 8, wherein the aggregated message further comprises the third message.

10. The computing system of claim 7, further comprising program instructions executable by the at least one processor to perform functions comprising:
storing a state of the at least one processor at a first time after a first task of the plurality of tasks has been caused to be executed;
causing a second task of the plurality of tasks to be executed; and
causing, after causing the second task to be executed, the at least one processor to restore the state at a second time so as to allow the first task to continue to execute, wherein the first time is different than the second time.

11. A method comprising:
determining, using at least one processor of a first computing device, that a first task associated with a second computing device and a second task associated with the second computing device are to be executed, wherein the first computing device is communicatively connected to the second computing device;
assigning the execution of the first task and the second task to the at least one processor of the first computing device;
generating an aggregated message that comprises (i) a first message that comprises an indication corresponding to the execution of the first task and (ii) a second message that comprises an indication corresponding to the execution of the second task; and
sending the aggregated message to the second computing device.

12. The method of claim 11,
wherein the indication corresponding to the execution of the first task comprises at least one of a result of the execution of the first task or a request generated by the execution of the first task, and
wherein the indication corresponding to the execution of the second task comprises at least one of a result of the execution of the second task or a request generated by the execution of the second task.

13. The method of claim 11, wherein determining that the first task associated with the second computing device and the second task associated with the second computing device are to be executed comprises:
determining that the first computing device has no tasks to be assigned for execution; and
determining that the second computing device has a task queue comprising the first task and the second task.

14. The method of claim 11, further comprising:
causing the first message and the second message to be sent to an aggregated-message queue, wherein the aggregated-message queue is associated with the second computing device.

15. The method of claim 14,
wherein the aggregated-message queue is associated with a message-size threshold,
the method further comprising:
before sending the aggregated message, determining that a size of the aggregated message is greater than the message-size threshold.

16. The method of claim 14,
wherein the aggregated-message queue is associated with a wait-time threshold,
the method further comprising:
before sending the aggregated message, determining that the aggregated message has been in the aggregated-message queue for a time period greater than the wait-time threshold.

17. The method of claim 11, further comprising:
before determining that the first task of the second computing device and the second task of the second computing device are to be executed:
determining that a plurality of tasks of the first computing device are to be executed by the at least one processor of the first computing device;
assigning the plurality of tasks of the first computing device to the at least one processor; and
causing the plurality of tasks of the first computing device to be executed.

18. The method of claim 17, further comprising:
causing a third computing device to execute at least one of the first task, the second task, and the plurality of tasks; and
receiving from the third computing device a third message that indicates a result of at least one of the execution of the first task, the execution of the second task, or the execution of the plurality of tasks.

19. The method of claim 18, wherein the aggregated message further comprises the third message.

20. The method of claim 17, further comprising program instructions executable by the at least one processor to perform functions comprising:
storing a state of the at least one processor at a first time after a first task of the plurality of tasks has been caused to be executed;
causing a second task of the plurality of tasks to be executed; and
causing, after causing the second task to be executed, the at least one processor to restore the state at a second time so as to allow the first task to continue to execute, wherein the first time is different than the second time.

21. A physical computer-readable medium having stored thereon program instructions executable by a first computing device to cause the first computing device to perform functions comprising:
determining, using at least one processor of the first computing device, that a first task associated with a second computing device and a second task associated with the second computing device are to be executed, wherein the first computing device is communicatively connected to the second computing device;
assigning the execution of the first task and the second task to the at least one processor of the first computing device;
generating an aggregated message that comprises (i) a first message that comprises an indication corresponding to the execution of the first task and (ii) a second message that comprises an indication corresponding to the execution of the second task; and
sending the aggregated message to the second computing device.

22. The physical computer-readable medium of claim 21,
wherein the indication corresponding to the execution of the first task comprises at least one of a result of the execution of the first task or a request generated by the execution of the first task, and
wherein the indication corresponding to the execution of the second task comprises at least one of a result of the execution of the second task or a request generated by the execution of the second task.

23. The physical computer-readable medium of claim 21, further comprising program instructions executable by the at least one processor to perform functions comprising:
before determining that the first task associated with the second computing device and the second task associated with the second computing device are to be executed:
determining that the first computing device has no tasks to be assigned for execution; and
determining that the second computing device has a task queue comprising the first task and the second task.

24. The physical computer-readable medium of claim 21, further comprising program instructions executable by the at least one processor to perform functions comprising:
causing the first message and the second message to be sent to an aggregated-message queue, wherein the aggregated-message queue is associated with the second computing device.

25. The physical computer-readable medium of claim 24,
wherein the aggregated-message queue is associated with a message-size threshold,
the physical computer-readable medium further comprising program instructions executable by the at least one processor to perform functions comprising:
before sending the aggregated message, determining that a size of the aggregated message is greater than the message-size threshold.

26. The physical computer-readable medium of claim 24,
wherein the aggregated-message queue is associated with a message-size threshold,
the physical computer-readable medium further comprising program instructions executable by the at least one processor to perform functions comprising:
before sending the aggregated message, determining that the aggregated message has been in the aggregated-message queue for a time period greater than the wait-time threshold.

27. The physical computer-readable medium of claim 21, further comprising program instructions executable by the at least one processor to perform functions comprising:
before determining that the first task of the second computing device and the second task of the second computing device are to be executed:
determining that a plurality of tasks of the first computing device are to be executed by the at least one processor of the first computing device;
assigning the plurality of tasks of the first computing device to the at least one processor; and
causing the plurality of tasks of the first computing device to be executed.

28. The physical computer-readable medium of claim 27, further comprising program instructions executable by the at least one processor to perform functions comprising:
causing a third computing device to execute at least one of the first task, the second task, and the plurality of tasks; and
receiving from the third computing device a third message that indicates a result of at least one of the execution of the first task, the execution of the second task, or the execution of the plurality of tasks.

29. The physical computer-readable medium of claim 28, wherein the aggregated message further comprises the third message.

30. The physical computer-readable medium of claim 27, further comprising program instructions executable by the at least one processor to perform functions comprising:
storing a state of the at least one processor at a first time after a first task of the plurality of tasks has been caused to be executed;
causing a second task of the plurality of tasks to be executed; and
causing, after causing the second task to be executed, the at least one processor to restore the state at a second time so as to allow the first task of the plurality of tasks to continue to execute, wherein the first time is different than the second time.
